(19) United States
(12) Patent Application Publication
(10) Pub. No.: US 2006/0268392 A1
(43) Pub. Date: Nov. 30, 2006

(54) Optical communication line and system with reduced polarization mode dispersion

(76) Inventors: Dario Setti, Montegrotto Terme (IT); Alessandro Schiffini, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/534,041

(22) PCT Filed: Nov. 8, 2002
(86) PCT No.: PCT/IT02/00708

§ 371 Date: Jun. 6, 2006

(51) Int. Cl. H01S 3/00

(52) U.S. Cl. 359/337.5

(57) ABSTRACT

An optical communication line for transmitting an optical signal having a predetermined wavelength has a plurality of spans and at least one PMD compensation device adapted to process the optical signal so as to obtain in output a polarized optical signal having associated a maximum power fraction of the optical signal. The PMD compensation device is inserted between two spans of the line.

The present invention relates to an optical communication line and an optical communication system with reduced Polarization Mode Dispersion (or PMD).

The present invention also relates to a use of a PMD compensating device between two spans of an optical communication line and a method for reducing the PMD of an optical signal which propagates along an optical communication line.

The characteristics of the optical pulses which propagate in an optical fiber are altered, among other things, due to the intrinsic birefringence of an optical fiber which is mainly due to manufacturing imprecision which involve, for example, a geometry of the core which is not perfectly circular and/or internal asymmetry. In fact, an optical pulse propagates along an optical fiber according to two fundamental linear polarization modes perpendicular to each other which, due to. the birefringence of the fiber, propagate along it with group speeds different from each other. In other words, the two modes undergo different time delays. This phenomenon, usually defined as PMD, can cause a time spreading of the optical pulses (which in some cases can also result in a division of them into two separate pulses). The time distance between the two perpendicular polarization modes is known as differential group delay (DGD).

Such a delay limits the maximum transmission bit rate of an optical communication system and thus limits its performance.

Moreover, the fundamental polarization modes and the differential group delay change in time in a stochastic manner (for example due to variations in outside temperature, displacements of the fiber and vibrations) making PMD a random phenomenon which is difficult to predict.

Another problematic characteristic of PMD consists in the fact that the aforementioned differential group delay depends upon the frequency of an optical pulse. In other words, different spectral components of an optical pulse can undergo different delays.

Finally, it is worth noting that the optical line lengths which can be crossed by optical signals without undergoing any opto-electronic regeneration can be very long thanks to the insertion of optical amplifiers in said line. This, however, contributes to the increase of the accumulation of PMD along a transmission line and to the consequent worsening in the performance of the optical communication system at the reception.

Up to now various devices and/or methods have been proposed to reduce the PMD in an optical communication system.

EP 1 100 217 discloses an optical communication system with a plurality of PMD compensators in cascade between one span and the other of the system. Each PMD compensator comprises a polarization adjustment section, a first and a second polarization beam splitter, a delay optical system, a first and a second control circuit and a PMD detector. The first beam splitter separates the optical signal into two components with two states of polarization L1 and L2. The component L1 is made to pass through the delay optical system and then combined again with the component L2 by the second beam splitter. The PMD detector detects the distortion of the optical signal due to PMD and accordingly controls the two control circuits. These circuits control the optical delay system and the polarization adjustment section so as to minimize the distortion of the signal due to PMD at the output of the compensation device. In a preferred embodiment, besides the PMD compensation device, there is also a further polarization adjustment section adapted to regulate the polarization of the signal so as to minimize the PMD along the line downstream of the compensation device (for example at the reception).

However, the disclosed compensation device only carries out a first order compensation (that is, of the differential group delay), ignoring the higher order PMD (i.e. the factors of PMD dependent upon the frequency). Therefore, the advantages obtained by this type of compensation are limited and, as also observed by J. M. Fini et al. (“Accumulation of Polarization-Mode Dispersion in cascades of compensated optical fibers”, IEEE Photonics Technology Letters, Vol. 13, No. 2, February 2001, pages 124-126), decrease as the transmission band increases. Moreover, in the aforementioned compensation device the optical delay system is difficult to implement and relatively bulky and the control circuit requires the use of very complicated and expensive algorithms and control electronics.

FR 2 795 184 discloses a PMD compensation device comprising a polarization converter, a polarization beam splitter and a feedback control circuit. The polarization converter is adapted to convert an optical input signal with any state of polarization into a linear state of polarization having a desired angle. The polarization beam splitter separates the optical signal coming from the polarization converter into two perpendicular polarization components (for example TE and TM) allowing only one of the two components to exit and suppressing the other. The control circuit comprises a photo-detector and a pass band electrical filter to extract a spectral component from the electrical signal at its input. Moreover, it is adapted to control the polarization converter so as to maximize the spectral component in output from the electrical filter. In other words, the polarization converter—suitably driven by the control circuit—converts the state of polarization of the optical input signal into a linear state of polarization with an angle such as to maximize the spectral component in output from the electrical filter. The use of this device is described at the end of an optical communication line, at the receiving station of an optical communication system. Moreover, the Applicant notes that the feedback is carried out on the basis of a single spectral component of the electrical signal.

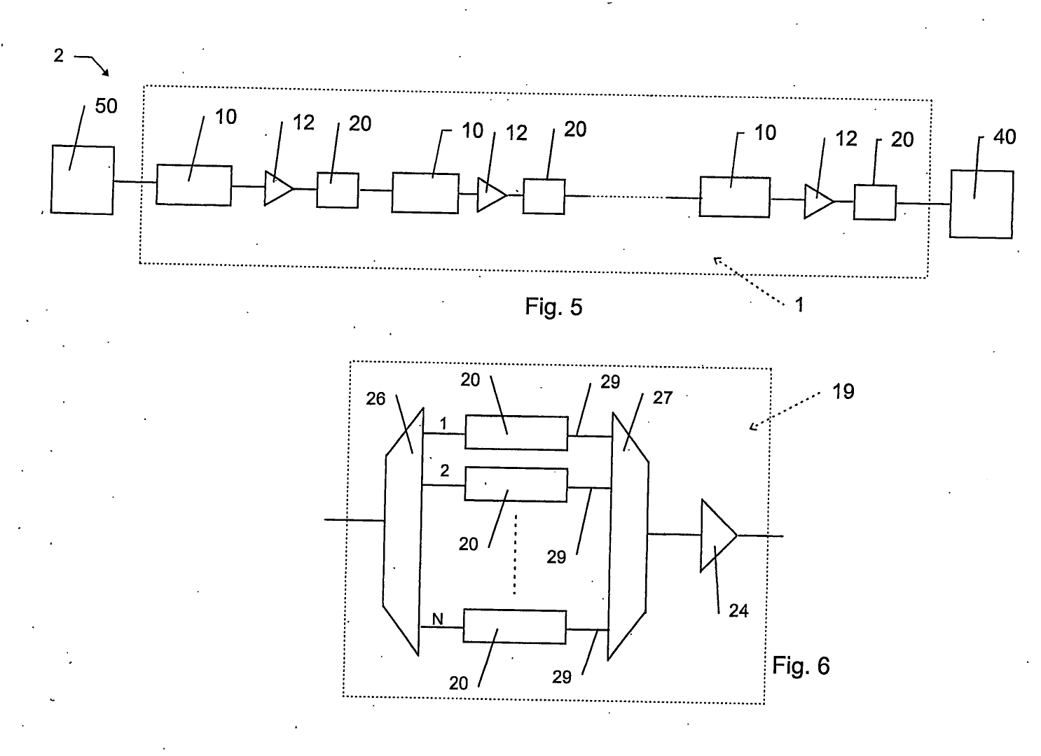

Henrik Sunnerud et al. (“A comparison between different PMD-compensation techniques”, Journal of Lightwave Technology, Vol. 20, No. 3, March 2002, pages 368-378) and M. Karlsson et al. (“A comparison of different PMD-compensation techniques”, ECOC 2000, vol. 2, pages 33-35), analyze and compare the performance of different PMD-compensation techniques. The techniques analyzed are: the “PSP” method which essentially consists in aligning the state of polarization of a signal inputted to an optical communication line with one of the principal states of polarization (PSPs); the first-order post compensation method, “1^{st}”, which consists in compensating the differential group delay (DGD) and the PSP by using a compensation element with both tunable DGD and PSP; the “1st-av” method which essentially consists in the “1st” method in which, however, the DGD is constant; the “Pol” method which essentially consists in maximizing the transmitted energy by using—at the end of a fiber optic link—a polarizer, a polarization controller and a feedback circuit; and a combination of such methods. From the comparison of the performance which was carried out, the Authors state that the “Pol” method of energy maximization at the end of the link, despite having the advantage of being inexpensive and simple to implement, is useful only for high PMD values and performs less well than the other techniques for low PMD values. From FIG. 5 of the article by M. Karlsson et al., the Applicant observes that this technique has, with respect to the other techniques, an improvement which is very limited and for values of the ratio between the normalized average DGD and the pulse width (<Δτ²>^{1/2}/τ₀>2) which are poorly representative of the fibers currently used in optical communication systems. In the regions of greater practical interest (for example, <Δτ²>^{1/2}/τ₀<1) this technique has, on the other hand, much worse performance with respect to the other techniques considered. As far as the other methods analyzed are concerned, the Applicant observes that some of them require the use of delay lines which are complex to implement. Moreover, such methods all require the use of a complicated and expensive control and feedback circuit.

Therefore, the methods and/or devices up to now proposed to reduce the PMD in an optical communication system do not allow satisfactory results to be obtained, they are difficult to implement and/or they are expensive.

The Applicant thus faced the technical problem of reducing the PMD in an optical communication line with a simple and effective technique.

The Applicant found that this can be obtained by using within an optical communication line—instead of or as well as at the end of the line—one or more devices adapted to process an input signal so as to obtain in output a polarized optical signal having associated a maximum power fraction of the input optical signal.

In fact, the Applicant observed that due to the PMD the degree of polarization of an optical signal can significantly decrease as the signal propagates along the optical communication line and found that a suitable repolarization of the signal within the optical communication line allows, as shown below, the PMD of the line to be remarkably reduced and, therefore, the performance of an optical communication system to be improved.

Therefore, in a first aspect thereof the present invention relates to an optical communication line for transmitting an optical signal having a predetermined wavelength comprising a plurality of spans and at least one PMD compensation device adapted to process said optical signal so as to obtain in output a polarized optical signal having associated a maximum power fraction of said optical signal, characterized in that said PMD compensation device is inserted between two spans of the line.

As already highlighted above in the discussion of the prior art, such a PMD compensation device—adapted to provide in output a polarized signal with maximization of the transmitted optical power—is simple to make and inexpensive. Moreover, the Applicant found that the use of one or more of such compensation devices, within an optical communication line (i.e. between the spans of the line) instead of or as well as at the end of the link (as, on the contrary, described by the aforementioned prior art documents) allows, as shown below, the PMD to be substantially reduced and, therefore, the performance of an optical communication system to be improved.

In the optical communication line of the invention the PMD is therefore effectively and simply reduced.

The Applicant observes that the PMD compensation device of the invention is adapted to search at predetermined time. intervals the maximum of the average power which can be obtained for the polarized optical signal, so as to obtain in output the maximum fraction of the average power of the input optical signal or a value about such a maximum fraction. In fact, at each predetermined time interval, the optical power associated with the polarized optical signal in output from the PMD compensation device is the result of said search for the maximum. Such a search is typically obtained through a feedback circuit. With typical feedback circuits currently available, said search result can not-be precisely the maximum power fraction of the optical signal in input but a value close to it.

Therefore, for the purposes of the present description and claims the expression “a maximum power fraction” is used to indicate the maximum fraction of the average power of the input optical signal or a value about such a maximum fraction.

In the present description and claims, the expression “polarized optical signal” is used to indicate an optical signal with a Degree of Polarization (DOP) of at least 0.9. Preferably, such an expression is used to indicate an optical signal having a degree of polarization of at least 0.95.

In turn, the expression “degree of polarization” is intended to indicate the percentage of the total power of an optical signal which is polarized. It is defined, at a point z, by the following relationship

$$DOP = \frac{\sqrt{{〈 {s}_{1} ( z , t ) 〉}_{T}^{2} + {〈 {s}_{2} ( z , t ) 〉}_{T}^{2} + {〈 {s}_{3} ( z , t ) 〉}_{T}^{2}}}{{〈 {P}_{0} ( z , t ) 〉}^{T}}$$

in which < >_{T} indicates the time average in an interval T, P₀ is the optical power associated with the train or pattern of pulses upon. which the measurement is carried out, s1, s2 and s3 are the parameters of a versor known in the art as Stokes versor s defined by the following relationships:

$$s = \frac{1}{{S}_{0}} ( \begin{matrix}{S}_{1} \\ {S}_{2} \\ {S}_{3}\end{matrix} ) = ( \begin{matrix}{s}_{1} \\ {s}_{2} \\ {s}_{3}\end{matrix} )$$

in which
S₀=|Eₓ²+|E_{y}|²;
S₁=|Eₓ|²−|E_{y}|²;
S₂=EₓE*_{y}+E*ₓE_{y};
S₃=i(E*ₓE_{y}−EₓE*_{y})
where the asterisk indicates the conjugated complex operation and E=(Eₓ, E_{y}) is a complex vector known in the art as Jones vector which describes an electric field which propagates in optical fiber in an orthogonal Cartesian reference. In general for an optical signal which propagates in optical fiber the aforementioned Stokes versor s is a function of the position z and of the frequency. It follows that, in general, the spectral components of the signal have a different polarization and that, therefore, in the time domain, the state of polarization of the signal varies along the time profile of the pulse causing its depolarization. In general, for a perfectly polarized pulse the DOP is equal to 1, whereas it tends towards zero in the case of marked depolarization.

The DOP can be measured through devices available on the market like, for example, the polarization analyzer AGILENT 8509B/C. The operation of such a device is described in the Product Note 8509-1 from the company Agilent Technologies available on 5 Nov. 2002 at the following Internet address: http://cp.literature.agilent.com/litweb/pdf/5091-2879E.pdf.

In the present description and claims, the expression “span” is used to indicate a portion of optical communication line used for the transmission of optical signals from one point to another situated at an appreciable distance (for example, of at least some km or tenths of km). Typically, the span comprises a transmission optical fiber suitable for the transmission of signals from one point to another situated at an appreciable distance. Typically, the span also comprises a chromatic dispersion compensation device.

In the present description and claims, the expression “a plurality of spans” is used to indicate at least two spans.

The dependent claims relate to particular embodiments of the invention.

Typically, in the optical communication line of the invention, said polarized optical signal in output from the PMD compensation device is linearly polarized.

In an embodiment, the PMD compensation device is adapted to obtain in output an optical signal polarized according to a predetermined (prefixed) state of polarization and to adjust the polarization of said optical signal so as to maximize the optical power associated with said optical signal polarized according to said predetermined state of polarization. In this embodiment, the PMD compensation device advantageously comprises a polarizer adapted to obtain in output said optical signal polarized according to said predetermined state of polarization. Typically, such a state of polarization is linear. Preferably, the PMD compensation device also comprises a polarization controller adapted to adjust the polarization of said optical signal. Advantageously, the PMD compensation device also comprises a control device adapted to receive a power fraction of the polarized optical signal in output from the polarizer, to analyze the signal received and to drive the adjustment introduced by the polarization controller so as to maximize the power of the polarized optical signal in output from the polarizer.

In an alternative embodiment, the PMD compensation device comprises a tunable polarizer adapted to obtain in output said polarized optical signal. Advantageously, in this embodiment, the PMD compensation device also comprises a control device adapted to receive a power fraction of the polarized optical signal in output from the tunable polarizer, to analyze the signal received and to drive the tunable polarizer so as to maximize the optical power associated with the polarized optical signal in output from the tunable polarizer.

Advantageously, the PMD compensation device also comprises an optical coupler adapted to draw a power fraction from the optical signal in output from the polarizer (or tunable polarizer) and to supply it to the control device.

Advantageously, each span comprises a transmission optical fiber length.

Advantageously, the optical communication line comprises at least one optical amplifier. Typically, the optical amplifier is positioned between two spans of the line. This allows the optical signal to be amplified after propagation along the upstream span. Advantageously, said optical amplifier is associated with the PMD compensation device. In an embodiment, the line comprises a further optical amplifier associated with the PMD compensation device. The association of an optical amplifier with the PMD compensation device allows possible power losses of the optical signal due to the compensation device (and, in particular, to the polarizer) to be compensated for. Preferably, the optical amplifier is positioned at the output of the PMD compensation device (in particular, downstream of the polarizer).

Preferably, at least one of the spans also comprises a chromatic dispersion compensation device. Advantageously,. the aforementioned PMD compensation device is associated with said chromatic dispersion compensation device. In an embodiment, the line comprises a further PMD compensation device associated with the chromatic dispersion compensation device. As far as the characteristics of this further PMD compensation device are concerned we refer to that which has been described above. Typically, the chromatic dispersion compensation device comprises an optical fiber.

Advantageously, the optical communication line comprises a plurality of PMD compensation devices cascaded among the spans of the line. As far as the characteristics of these further PMD compensation devices are concerned we refer to what described above.

In a preferred embodiment, the optical communication line comprises, at its output end, a further PMD compensation device. This allows, when needed and depending on the system requirements, the PMD to be compensated even at the end of the line (typically immediately upstream of the receiving station of an optical communication system). As far as the characteristics of this further PMD compensation device are concerned we refer to what described above.

In an embodiment, the optical communication line is adapted to transmit a plurality of N optical signals with wavelengths different from each other and comprises, between two spans, a plurality of N optical paths, one for each of said N optical signals, each comprising a PMD compensation device adapted to process a respective optical signal of said N optical signals so as to obtain in output a respective polarized optical signal having associated a maximum power fraction of said respective optical signal. As far as the structural and functional characteristics of the PMD compensation device of each optical path are concerned we refer to what described previously. Typically, said N optical signals are transmitted along the optical communication line by wavelength multiplexing. Typically, said N optical paths are adapted to draw said N optical signals from the upstream span and to supply the N polarized optical signals to the downstream span. Advantageously, the optical communication line also comprises a power regulating device associated with said plurality of N optical paths adapted to regulate the power of the polarized optical signals. Advantageously, said power regulating device is adapted to substantially equalize the power of the polarized optical signals at the output of said plurality of N optical paths. In an embodiment, said power regulating device comprises a plurality of optical attenuators each associated with a respective optical path. In an alternative embodiment, said power regulating device comprises a plurality of optical amplifiers each associated with a respective optical path.

According to a further embodiment, said power regulating device comprises a dynamic gain equalizer positioned downstream of said plurality of N optical paths.

In an embodiment, the line also comprises a demultiplexing device having an input for receiving said plurality of N optical signals and N outputs connected to said N optical paths, said demultiplexing device being adapted to separate said N optical signals and to supply them to the respective optical paths. In this embodiment, the line advantageously also comprises a multiplexing device having N inputs connected to said N optical paths and an output, said multiplexing device being adapted to combine on said output the polarized optical signals coming from the N optical paths.

In an alternative embodiment, the line comprises an optical circulator having an input port for the plurality of N optical signals and N ports connected to said N optical paths. Typically, the optical circulator also comprises an output port for the polarized optical signals coming from the N optical paths. Preferably, in this embodiment, each optical path comprises, at a first end thereof in proximity to the respective port of the optical circulator, a pass band filter adapted to let the respective optical signal pass and to reflect back the other N-1 optical signals. Advantageously, each optical path also comprises, at a second end thereof opposite the first end, a reflecting element adapted to reflect back, towards the respective port of the optical circulator, at least one portion of the respective optical signal. Advantageously, the reflecting element has a variable reflection coefficient and each optical path comprises a control circuit of said reflection coefficient so as to regulate the level of optical power of the respective polarized optical signal.

In a second aspect thereof, the invention also relates to an optical communication system comprising an optical communication line as described above, a transmitting station adapted to supply said optical signal or said plurality of N optical signals to the line and a receiving station to receive said optical signal or said plurality of N optical signals from the line.

As far as the structural and functional characteristics of the line and of the PMD compensation device are concerned we refer to what described above.

In a third aspect thereof, the present invention also relates to a use of a PMD compensation device between two spans of an optical communication line, said device being adapted to process an input optical signal having a predetermined wavelength so as to obtain in output a polarized optical signal having associated a maximum power fraction of said input optical signal.

As far as the structural and functional characteristics of the PMD compensation device are concerned we refer to what described above.

In a fourth aspect thereof, the present invention also relates to a method for reducing the PMD of an optical signal having a predetermined wavelength which propagates along an optical communication line comprising at least two spans, said method comprising the steps of
a)processing the optical signal coming from one of the two spans so as to obtain a polarized optical signal having associated a maximum power fraction of said optical signal; and
b)supplying said polarized optical signal to the other of the two spans.

Typically, in step a) the processing is carried out so as to obtain a linearly polarized optical signal.

Typically, in step a) the processing is carried out so as to obtain a polarized optical signal according to a predetermined state of polarization and to adjust the polarization of the optical signal coming from one of the two spans so as to maximize the optical power associated with said polarized optical signal.

Characteristics and advantages of the invention shall now be illustrated with reference to embodiments represented as a non-limiting example in the attached drawings in which:

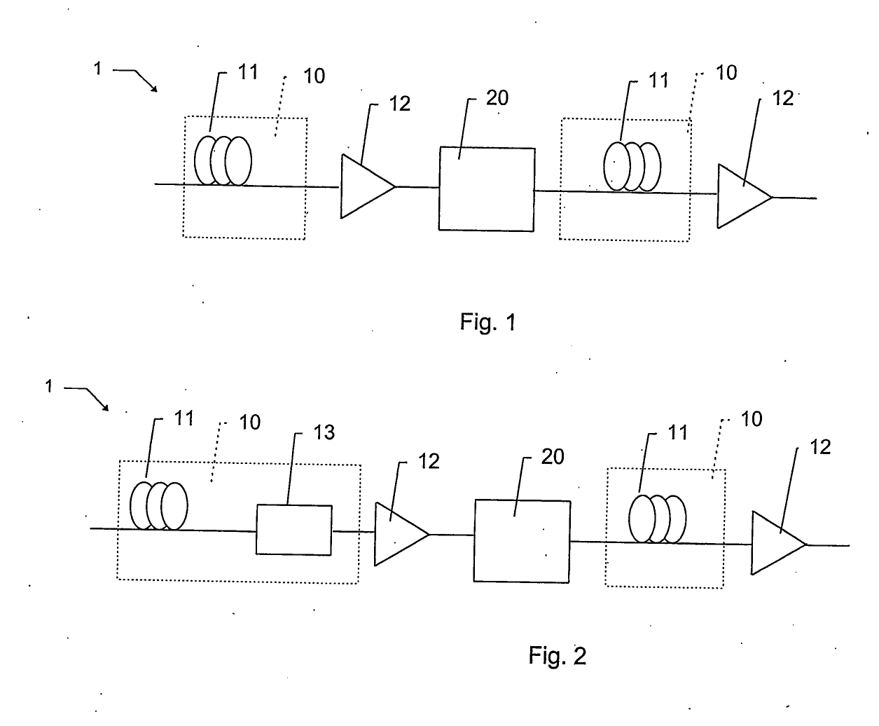

FIG. 1 shows an optical communication line according to a first embodiment of the invention;

FIG. 2 shows an optical communication line according to a second embodiment of the invention;

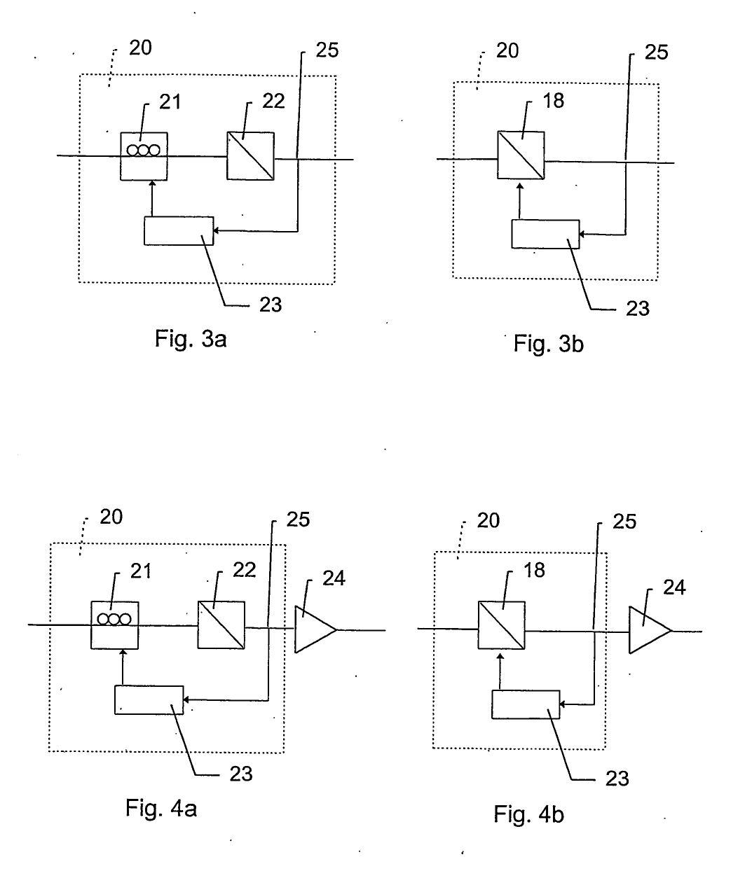

FIGS. 3a and 3b show a PMD compensation device according to a first and second embodiment of the invention;

FIGS. 4a and 4b respectively show the PMD compensation devices of FIGS. 3a and 3b with which an optical amplifier is associated;

FIG. 5 shows an optical communication system according to an embodiment of the invention;

FIG. 6 shows a first embodiment of a PMD compensation scheme in the case of WDM transmission;

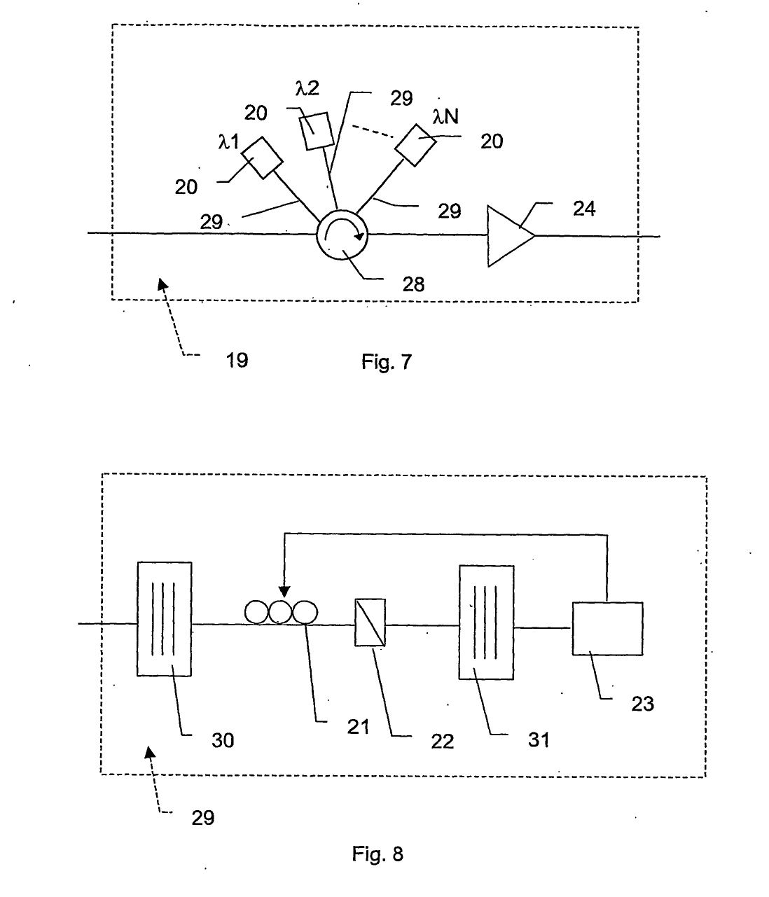

FIG. 7 shows a second embodiment of a PMD compensation scheme in the case of WDM transmission;

FIG. 8 shows an optical path provided for the scheme of FIG. 7;

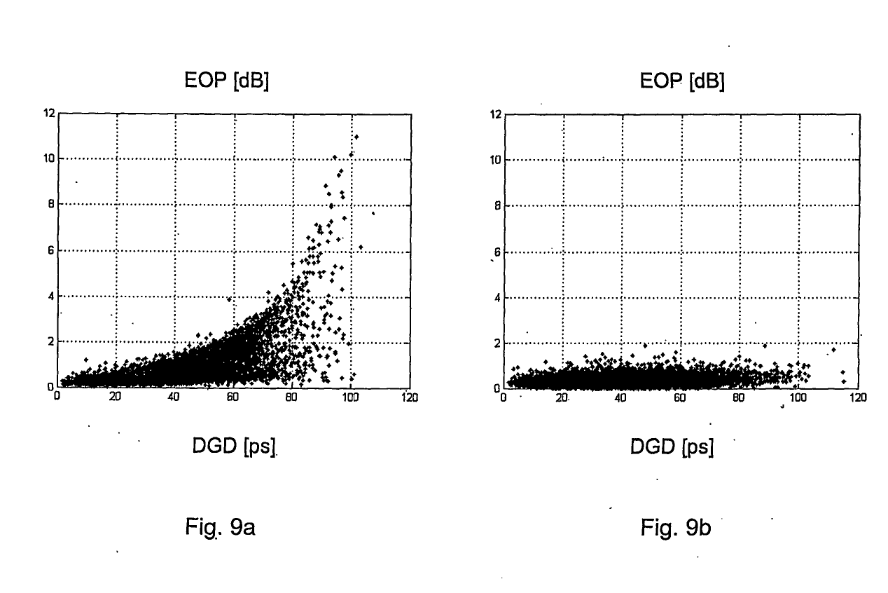

FIGS. 9a and 9b show the eye opening penalty (EOP) values versus the instantaneous DGD in the absence (FIG. 9a) and in the presence (FIG. 9b) of PMD compensation devices according to the invention, obtained through simulations on an optical communication line in the case of NRZ transmission;

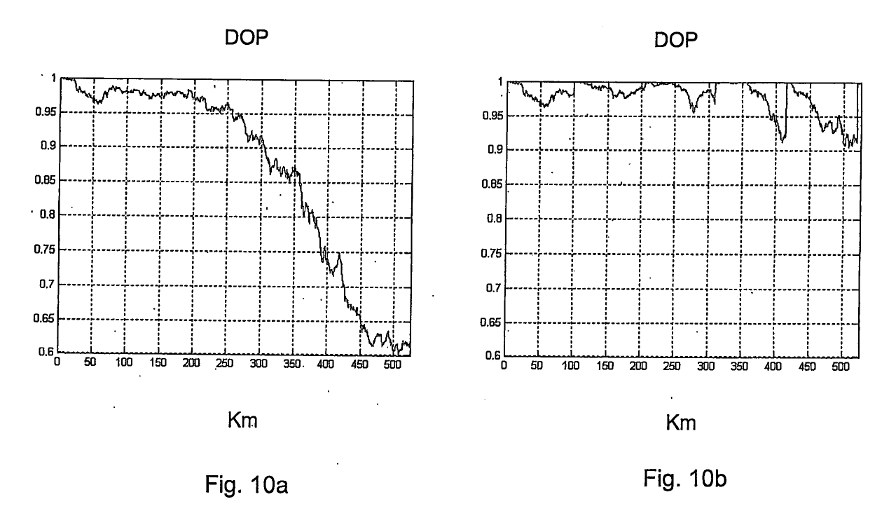

FIGS. 10, 11 and 12 respectively show the evolution of the DOP (Degree of Polarization) along the simulated line, the eye diagram and a portion of pattern received at the end of the simulated line in the case of absence (FIGS. 10a, 11a, 12a) and presence (FIGS. 10b, 11b, 12b) of PMD compensation according to the invention and NRZ transmission;

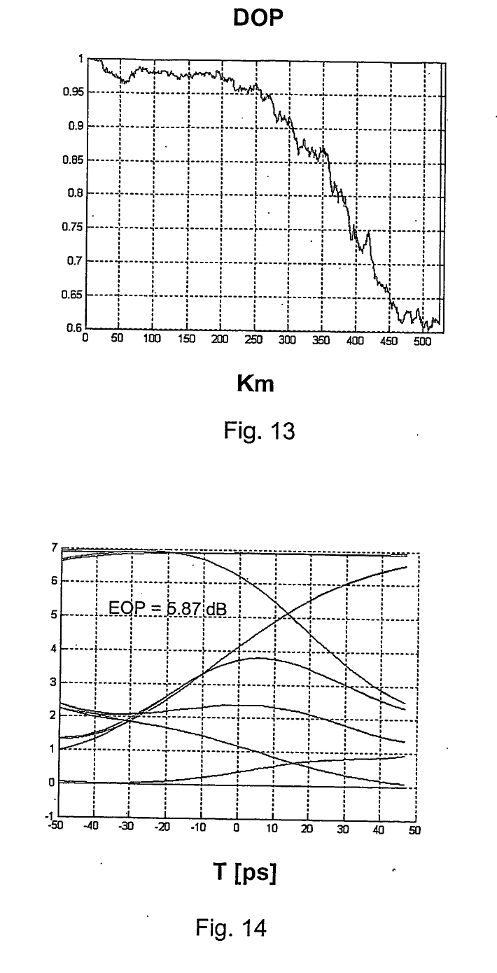

FIGS. 13, 14e 15 respectively show the evolution of the DOP along the simulated line, the eye diagram and a portion of pattern received at the end of the line for the same embodiment of fiber considered in FIGS. 10-12, but with a single PMD compensation device placed at the end of the line according to the prior art;

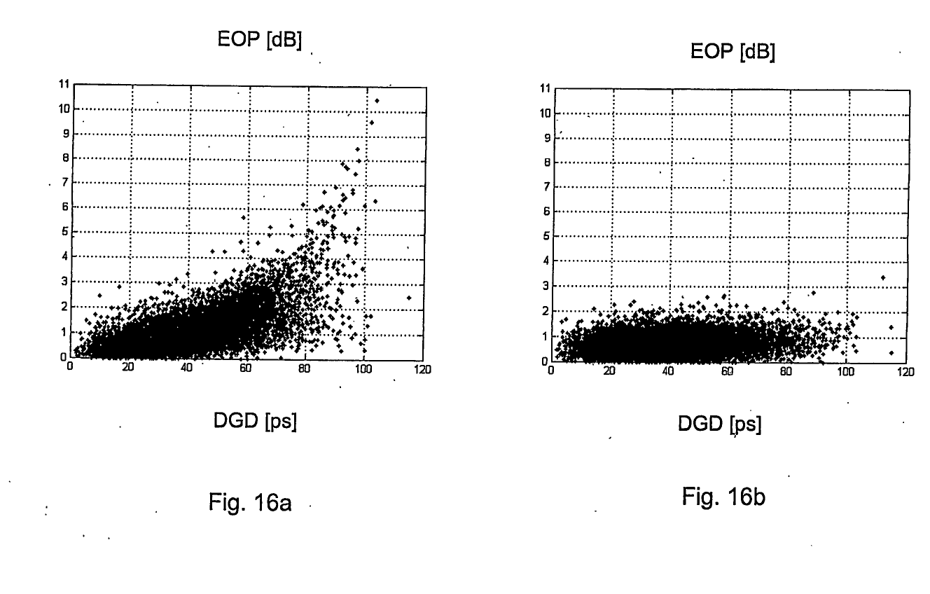

FIGS. 16a and 16b show the eye opening penalty (EOP) versus the instantaneous DGD in the absence (FIG. 16a) and in the presence (FIG. 16b) of PMD compensation devices according to the invention, obtained through simulations on an optical communication line in the case of RZ transmission;

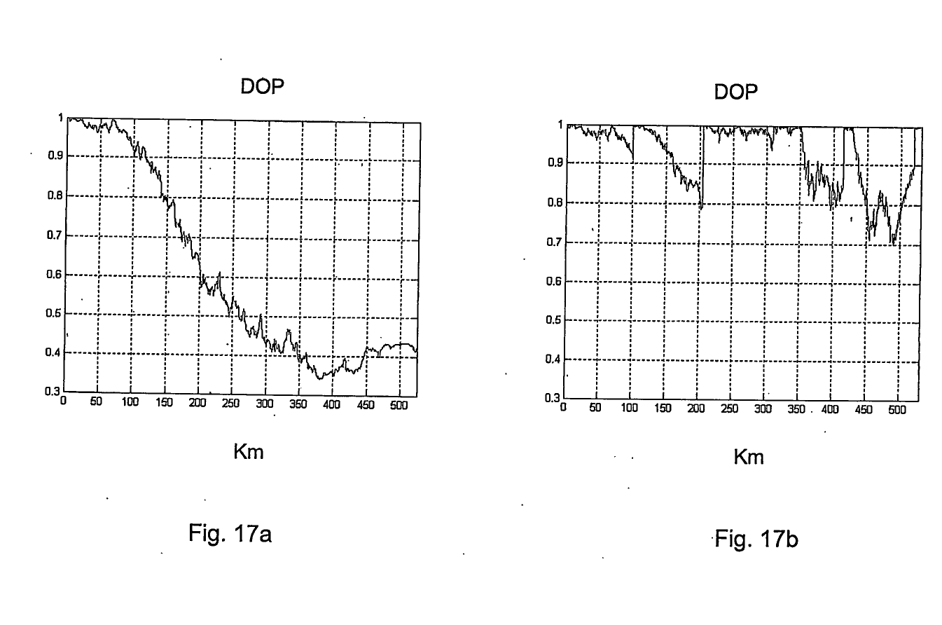

FIGS. 17, 18 and 19 respectively show the evolution of the DOP along the simulated line, the eye diagram and a portion of pattern received at the end of the simulated line in the case of absence (FIGS. 17a, 18a, 19a) and presence (FIGS. 17b, 18b, 19b) of PMD compensation according to the invention and RZ transmission;

FIGS. 20, 21 and 22 respectively show the evolution of the DOP along the simulated line, the eye diagram and a portion of pattern received at the end of the simulated line for the same embodiment of fiber considered in FIGS. 17-19, but with a single PMD compensation device placed at the end of the line according to the prior art;

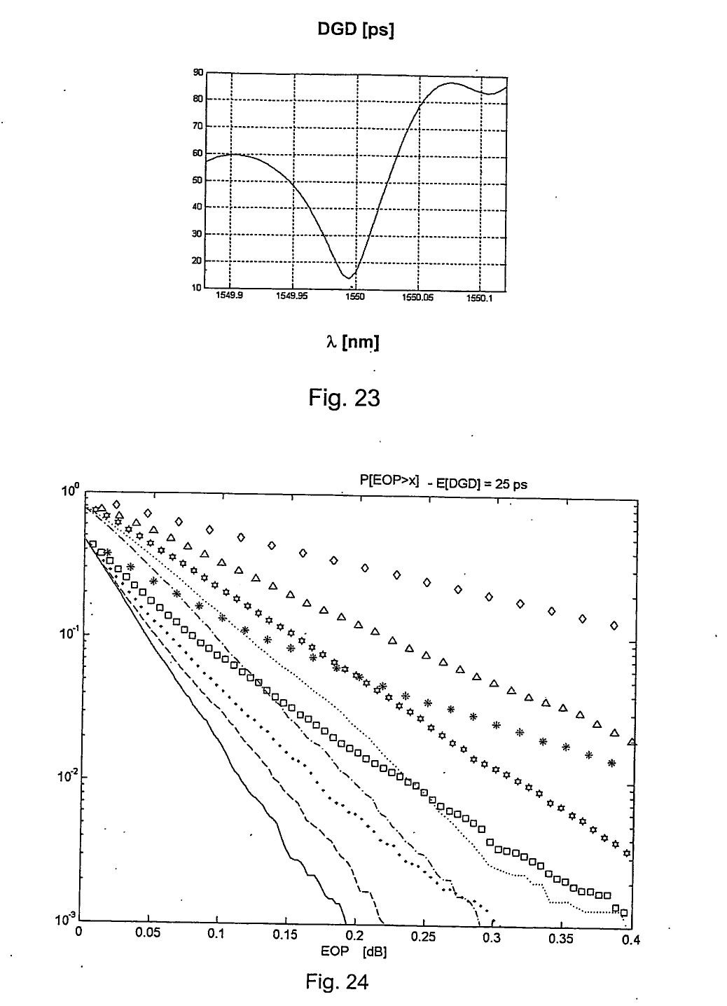

FIG. 23 shows an example of instantaneous DGD variation within the typical band of an optical signal;

FIG. 24 shows the P[EOP>x] (defined afterwards in the description) in the case of NRZ transmission of a signal at 10 Gbit/s for an average DGD of 25 ps;

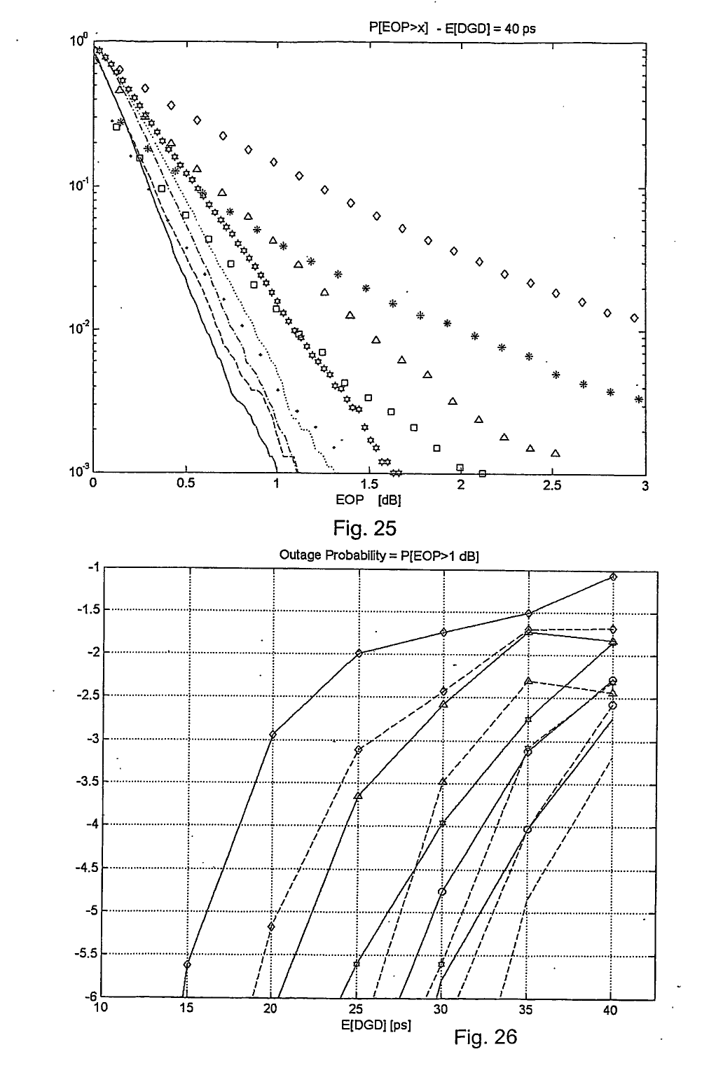

FIG. 25 shows the P[EOP>x] in the case of NRZ transmission of a signal at 10 Gbit/s for an average DGD of 40 ps;

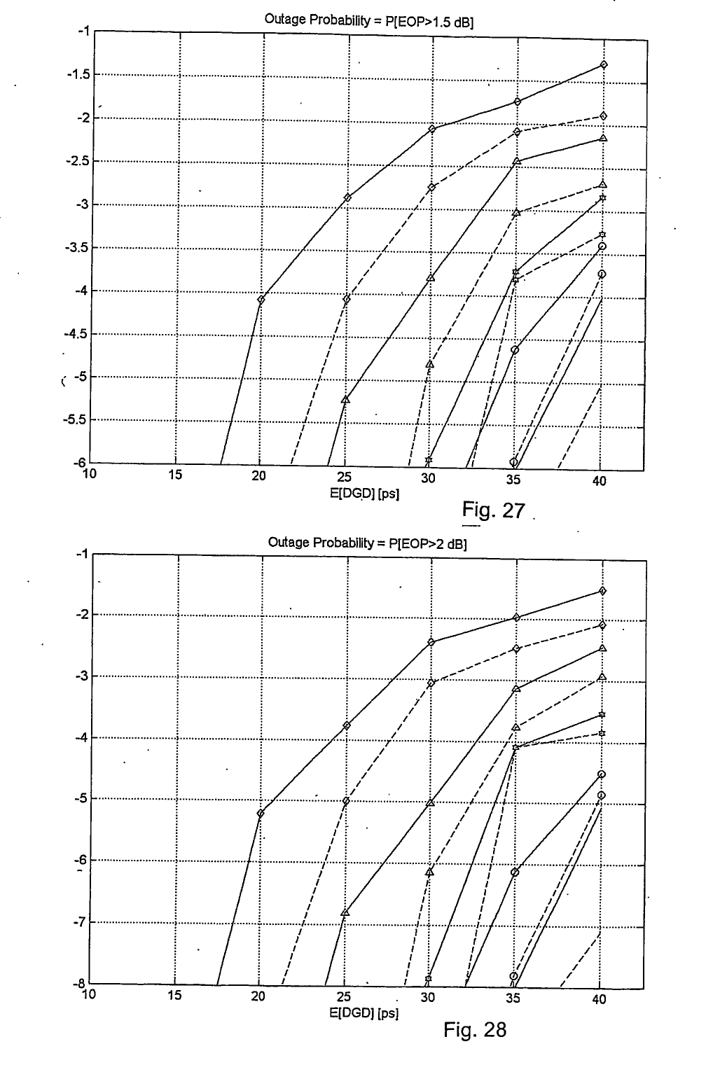

FIGS. 26-28 show the outage probability (defined afterwards in the description) versus the average DGD at the end of the line in the case of NRZ transmission for an EOP threshold of 1 dB, 1.5 dB and 2 dB respectively;

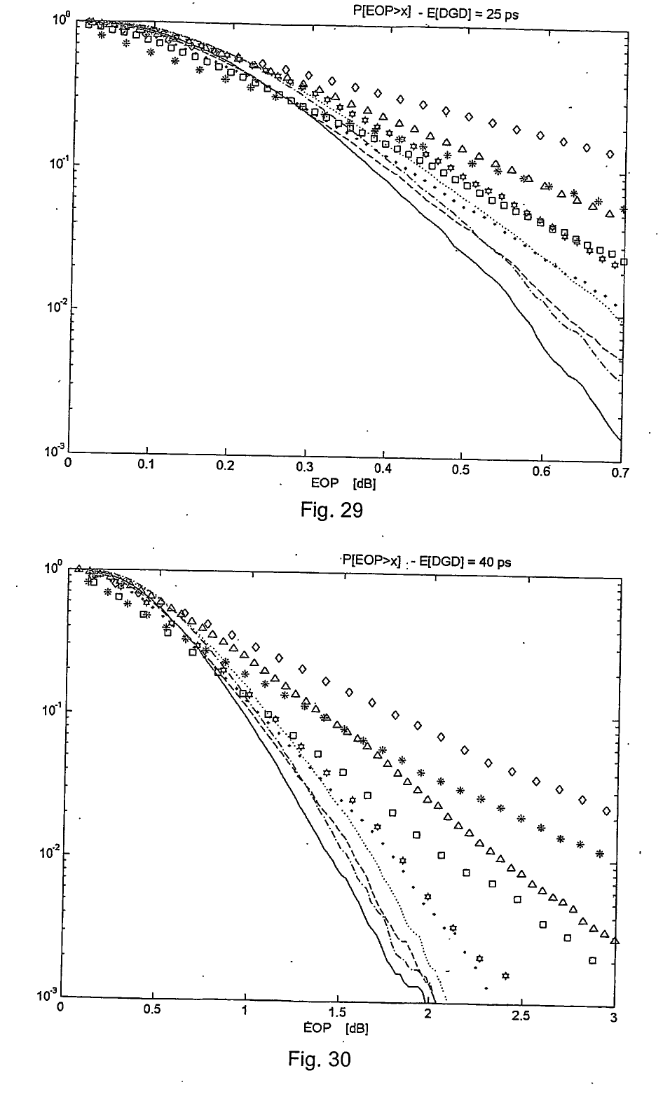

FIG. 29 shows the P[EOP>x] in the case of RZ transmission of a signal at 10 Gbit/s for an average DGD of 25 ps;

FIG. 30 shows the P[EOP>x] in the case of RZ transmission of a signal at 10 Gbit/s for an average DGD of 40 ps;

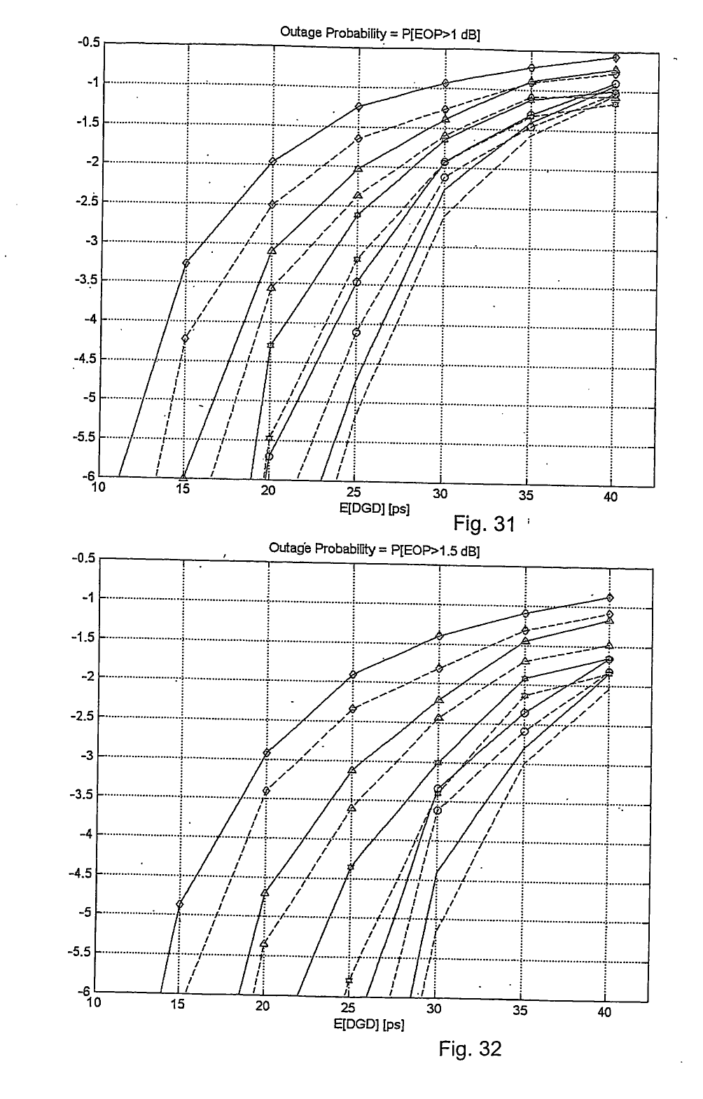

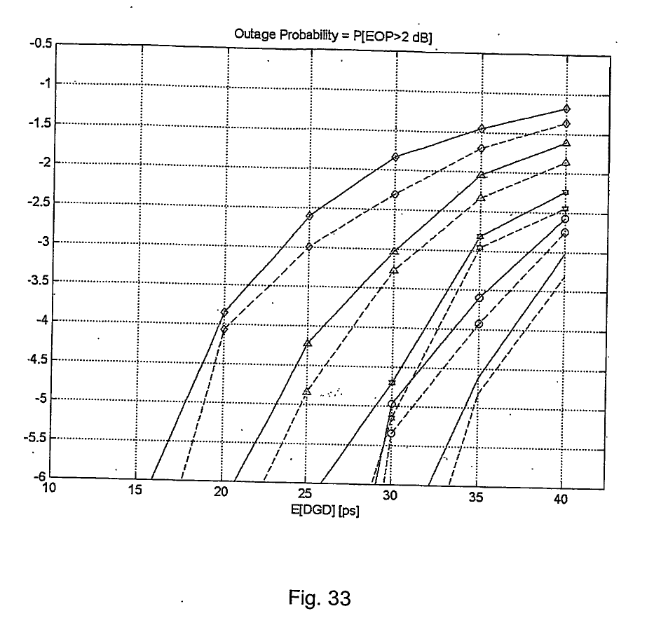

FIGS. 31-33 show the outage probability versus the average DGD at the end of the line in the case of RZ transmission for an EOP threshold of 1 dB, 1.5 dB and 2 dB respectively.

In FIG. 1 an optical communication line 1 for transmitting an optical signal is shown. The line 1 comprises two optical fiber spans 10, two optical amplifiers to amplify the optical signal at the end of each span 10 and a PMD compensation device 20 inserted between one span and another.

Each span 10 comprises a transmission optical fiber length 11. Typically, the transmission optical fiber length 11 comprises a conventional optical fiber typically used for long-haul signal transmission, preferably of the single mode type.

Typically, the transmission optical fiber length 11 has a length of some tens of Km. For example 80 or 100 Km.

Typically, the optical amplifier 12 is of the active optical fiber conventional type. For example, it comprises a length of active optical fiber doped with erbium and a pump source (for example, a laser source) to pump the active optical fiber at a pumping wavelength λp. The pump source is coupled with an input end of the active optical fiber through a coupler (for example of the fused fiber type)—preferably wavelength selective—so that the signal and pumping light propagate together through the active optical fiber.

However, according to the needs of the system, the pump source can also be coupled with the output end of the active fiber so that the signal and pumping light propagate in opposite directions through the active fiber. Alternatively, a respective pump source can be coupled with each end of the active fiber.

In the case of erbium doped active optical fiber, the wavelength λₚ of the pumping signal is typically equal to about 980 or 1480 nm.

Moreover, the optical amplifier 12 can possibly also comprise an optical isolator for blocking the backward reflections of the signal light.

Moreover, the optical amplifier 12 can possibly comprise more than one optical amplification stage.

The PMD compensation device 20 is adapted to process the optical signal at its input coming from the upstream span 10 so as to obtain in output a polarized optical signal having associated a maximum power fraction of the input optical signal. Said polarized optical signal is then supplied to the downstream span 10.

According to the embodiment illustrated in FIG. 3a, the PMD compensation device 20 is adapted to supply in output an optical signal polarized according to a prefixed state of polarization and to adjust the polarization of the input optical signal so as to maximize in output the optical power associated with such a prefixed state of polarization. Such a device 20 comprises a polarization controller 21, a polarizer 22 and a control device 23.

The polarization controller 21 is adapted to convert any state of polarization at its input into a linear state of polarization oriented according to a desired angle. The polarizer 22 is adapted to obtain in output an optical signal having a predetermined linear state of polarization. The control device 23 is adapted to control the polarization controller 21 so as to maximize the optical power in output from the polarizer 22. In this way, the polarization controller 21 adjusts the polarization of the optical signal at its input so as to maximize the optical power in output from the polarizer 22.

More particularly, in the case in which the optical pulse in input to the PMD compensation device is a polarized pulse (i.e. having all of the time or spectral components with associated the same state of polarization) according to any state of polarization, the polarization controller 21 shall convert the state of polarization of the input optical pulse into the linear state of polarization supplied in output from the polarizer 22. In this way, the polarizer 22 shall supply in output substantially 100% of the input optical pulse power. On the other hand, in the more realistic case of an input optical pulse partially depolarized due to propagation along the optical fiber span 10 upstream of the PMD compensation device 20, such an optical pulse will have many time (or spectral) components with a more or less random state of polarization, with one of which most of the optical power of the pulse will be associated. In this case, the polarization controller 21 will adjust the polarization of the input optical pulse so that the time (or spectral) component with greater optical power has, in input to the polarizer 22, a linear state of polarization substantially aligned with that of the polarizer 22. Therefore, the polarizer 22 will supply in output substantially all of the power associated with the time (or spectral) component at greater optical power (since it has linear polarization substantially aligned with that of the polarizer 22) whereas of the other time (or spectral) components it will supply in output only their power contribution along the predetermined linear state of polarization of the polarizer 22.

This compensation technique can bring an optical power loss which, however, can be compensated, as described hereafter with reference to FIG. 4, with an optical amplifier. At most, the PMD compensation device according to the invention loses substantially 50% of the input optical power.

Typically, the PMD compensation device 20 also comprises an optical coupler 25 adapted to draw a minimum power fraction (for example 5%) from the optical signal coming out from the polarizer 22 and to supply it to the control device 23. Moreover, the control device 23 comprises a photo-detector (not shown) adapted to convert the fraction of optical signal drawn by the optical coupler 25 into an electrical signal. Moreover, it typically comprises an electrical circuit adapted to implement a maximum power search algorithm and to drive the polarization controller 21 so as to seek a maximum value of the optical power fraction in output from the polarizer 22.

In the PMD compensation device according to the invention, the feedback is carried out based upon a simple measurement of the power associated with the whole spectrum of the optical signal. With respect to the prior art described above, in which, for example, the feedback is based upon the measurement of the DOP (Degree of Polarization), the control used according to the invention is therefore much simpler to implement, less expensive, faster and more reliable. Moreover, with respect to the prior art described above (FR 2 705 184), in which the. feedback is based upon the analysis of a spectral component of the electrical signal, the control used according to the invention is simpler, less expensive and more reliable.

FIG. 4a shows the PMD compensation device 20 of FIG. 3a with which an optical amplifier 24 is associated in output. Advantageously, the optical amplifier 24 operates in saturation. In other words, it has a constant output power value, independently of the input optical signal power value. This ensures that the optical signal sent along the downstream span 10 always has the same power value.

The presence of the amplifier 24 has the advantage of compensating for the power losses of the optical signal caused by the compensation device 20, and in particular by the polarizer 22 due to the depolarization of the signal during propagation along the upstream optical fiber spans 10.

Typically, the optical amplifier 24 is of the active optical fiber conventional type. For example, it is of the active optical fiber type doped with erbium as described above.

According to an alternative, the power losses of the optical signal introduced by the compensation device 20 can be compensated for by the optical amplifier 12 associated with the upstream span 10. In this case, the optical amplifier 12 is advantageously arranged downstream both of the optical fiber length 11 and of the PMD compensation device 20.

In an alternative embodiment shown in FIG. 3b or 4b, the PMD compensation device is totally analogous to that of FIG. 3a or 4a apart from the fact that it comprises, instead of the polarizer 22 (having a fixed output polarization state) and of the polarization controller 21 described above, a tunable polarizer 18 (having variable output polarization state). In this case, the control device 23 is adapted to command the tunable polarizer 18 so that it supplies in output the state of polarization which maximizes, depending on the input signal, the output optical power. For example, tunable polarizers are available on the market from the company STANDA (Vilnius, Lithuania).

FIG. 2 shows a preferred embodiment of the communication line 1 which is totally the same as that of FIG. 1 apart from the fact that it also comprises a chromatic dispersion compensation device 13.

In FIG. 2, such a chromatic dispersion compensation device 13 is positioned at the output end of the first span 10, upstream of the PMD compensation device 20. However, it can also be positioned at the input end of the first span 10, at the input end of the second span 10 (downstream of the PMD compensation device 20) or at the output end of the second span 10. Moreover, the line 1 can also comprise a plurality of chromatic dispersion compensation devices suitably positioned along it according to the system requirements.

The chromatic dispersion compensation device 13 can be any device conventionally known for chromatic dispersion compensation. For example, it can comprise an optical fiber having high chromatic dispersion values (typically at least 20 ps/(nm*Km) at the wavelength of the optical signal) or a fiber optic grating.

In the embodiment illustrated in FIG. 2, the PMD compensation device 20 is positioned downstream both of the optical fiber length 11 and of the chromatic dispersion compensation device 13 so as to compensate for the PMD introduced by both. Alternatively, the PMD compensation device 20 can be positioned downstream of the optical fiber length 11 and upstream of the chromatic dispersion compensation device 13. According to another alternative, two PMD compensation devices 20 can be provided for, one downstream of the optical fiber length 11 to compensate for the PMD introduced by such an optical fiber 11 and one downstream of the chromatic dispersion compensation device 13 to compensate for the PMD introduced by the device 13.

Even if in the embodiments illustrated in FIGS. 1 and 2 only two fiber optic spans 10 are shown with a PMD compensation device 20 placed between them, the line 1 can also comprise a greater number of spans. In this case, the line 1 can also comprise a plurality of PMD compensation devices 20 arranged between one span and the next and, possibly, also at the end of the last span. The number and the position of the devices 20 shall be selected so as to effectively compensate for the PMD of line 1 according to the system parameters and requirements. For example, in the case of spans with a high PMD with respect to the other spans, they will be positioned downstream of the high PMD spans or both upstream and downstream of such spans.

FIG. 5 shows an optical communication system 2 comprising a transmitting station 50, an optical communication line 1 and a receiving station 40.

In turn, the line 1 comprises a plurality of fiber optic spans 10, a plurality of optical amplifiers 12 and a plurality of PMD compensation devices 20.

As far as the description of the spans 10, of the optical amplifiers 12 and of the devices 20 and the number and positioning of the devices 20 along the line 1 are concerned, we refer to what stated above.

In the embodiment shown in FIG. 5, the line 1 also comprises a PMD compensation device 20 at the end of the last span 10, before the receiving station 40.

Moreover, even if not shown in the figures, the optical communication system 2 preferably also comprises a suitable number of conventional chromatic dispersion compensation devices (and, possibly, a further suitable number of PMD compensation devices associated with them).

Typically, the transmitting station 50 comprises a laser source adapted to supply an optical signal, an optical modulator and an optical power amplifier (not shown).

In the case of WDM transmission, the transmitting station 50 comprises a plurality of laser sources adapted to supply a plurality of optical signals with wavelengths different from each other, a corresponding plurality of optical modulators, at least one wavelength division multiplexer device and an optical power amplifier (not shown).

In any case, the transmitting station 50 can also comprise a chromatic dispersion precompensation section.

The laser sources are adapted to emit continuous optical signals at the typical wavelengths of fiber optic telecommunications like, for example, in the range of about 1300-1700 nm and, typically, in the third transmission window of optical fibers around 1500-1700 nm.

Typically, the optical modulators are conventional amplitude modulators, for example, of the Mach Zehnder interferometric type. They are driven by respective electrical signals carrying the main information to be transmitted along the optical communication line 1 so as to modulate the intensity of the continuous optical signals in output from the laser sources and to supply a plurality of optical signals at a predetermined bit rate. For example, said bit rate is 2.5 Gbit/s, 10 Gbit/s or 40 Gbit/s.

The optical signals thus modulated are then wavelength multiplexed by one or more multiplexer devices arranged in one or more multiplexing sub bands.

Such multiplexer devices comprise, for example, a conventional fused fiber or planar optical coupler, a Mach-Zehnder device, an AWG (Arrayed Waveguide Grating), an interference filter and/or a micro-optic filter and the like.

The multiplexed optical signals in output from the multiplexer device are then amplified by the optical power amplifier and sent along the optical communication line 1.

The optical power amplifier is, for example, a conventional active optical fiber amplifier doped with erbium as described above.

According to an embodiment, the transmitting station 50 also comprises a plurality of wavelength converter devices.

In this case, the laser sources emit continuous optical signals of whatever wavelength, the same as or different from each other, and the wavelength converter devices convert such wavelengths into a corresponding plurality of wavelengths which are different from each other and suitable for transmission along the optical communication line 1.

Such wavelength converter devices are adapted to receive a signal at a generic wavelength and to convert it into a signal with a predetermined wavelength according to what described, for example, in U.S. Pat. No. 5,267,073.

Each wavelength converter device preferably comprises a photodiode to convert the optical signal into an electrical one, a laser source and an electro-optic modulator—for example of the Mach-Zehnder type—to modulate the optical signal generated by the laser source at the predetermined wavelength, with the electrical signal converted by the photodiode.

Alternatively, such a converter device can comprise a photodiode and a laser diode directly modulated by the electrical signal of the photodiode so as to convert the optical signal at the predetermined wavelength.

The receiving station 40 typically comprises a photodetector (not shown) to convert the optical signal into a corresponding electrical signal.

In the case of WDM transmission, the receiving station 40 typically comprises at least one demultiplexer device and a plurality of photodetectors (not shown).

The demultiplexer device comprises one or more conventional devices, arranged in one or more demultiplexing sub bands, adapted to separate from each other the optical signals at different wavelength.

Such devices comprise, for example, a conventional fused fiber or planar optics coupler, a Mach-Zehnder device, an AWG (Arrayed Waveguide Grating), an interference filter and/or a micro-optic filter and the like.

The optical signals in output from the demultiplexer device are then converted into corresponding electrical signals by the corresponding plurality of photodetectors.

These photodetectors are, for example, conventional photodiodes.

The electrical signals in output from the photodetectors are then processed depending on the applications.

Of course, even if they are not described in detail, the teachings of the invention applied in a totally analogous manner also to the case of bidirectional signal transmission along the optical communication line 1. In this case, the PMD of the outgoing optical signal and of the return optical signal will be compensated independently from each other with two suitable PMD compensation devices 20.

In FIG. 6 an embodiment of a PMD compensation scheme 19 in the case of WDM transmission is shown.

In this regard, the Applicant observes that since the polarization evolution of an optical signal depend's upon its wavelength, in the case of WDM transmission, it is advisable to compensate the PMD of each individual signal (or channel) independently from the others.

In the PMD compensation scheme 19 of FIG. 6 there is provided a demultiplexer 26, a plurality of N optical paths 29 in parallel, each with a PMD compensation device 20, a multiplexer 27 and, preferably, an optical amplifier 24 downstream of the multiplexer 27.

The demultiplexer 26 is, for example, a device with one input and N outputs of the type previously described with reference to the receiving station 40 and is adapted to separate the plurality of optical signals onto the different optical paths 29 according to their wavelength.

A PMD compensation device 20 according to the invention (for example of the type described earlier with reference to FIG. 3a or 3b) is associated with each of the N outputs of the demultiplexer.

The N demultiplexed optical signals are then processed in parallel by the N PMD compensation devices 20 and then sent to N inputs of the multiplexer 27.

The multiplexer 27 is, for example, a device with N inputs and one output of the type previously described with reference to the transmitting station 50 and is adapted to combine on said output the N polarized optical signals coming from the N devices 20.

The optical signals combined on said output are then amplified by the optical amplifier 24.

In a preferred embodiment (not shown), in the PMD compensation scheme 19 there is also provided a power regulator device. Typically, such a power regulator device is adapted to guarantee that the N optical signals at different wavelengths all have substantially the same optical power at the input of the optical amplifier 24 or, in any case, of the downstream span 11. For example, such a power regulator device comprises a conventional dynamic gain equalizer arranged downstream of the multiplexer 27. Alternatively, the power regulator device comprises a plurality of optical attenuators arranged downstream of each PMD compensation device 20 and upstream of the multiplexer 27. For example, such optical attenuators have a constant output power. Alternatively, it is possible to use variable attenuators and a suitable feedback circuit for each optical path, with the feedback circuits of the various optical paths suitably in communication with each other to substantially equalize the power of the optical signals in output from the PMD compensation devices 20.

Moreover, instead of or as well as the optical amplifier 24, in the PMD compensation scheme 19 it can be provided an optical amplifier (not shown) associated with each PMD compensation device 20, upstream of the multiplexer 27. In an embodiment, such optical amplifiers upstream of the multiplexer 27 operate in saturation so as to have a constant output power. In this case, they can carry out the function of the aforementioned power regulator device.

In FIG. 7 an alternative embodiment of the PMD compensation scheme 19 is shown.

In this embodiment the demultiplexing and multiplexing of the signals is carried out by using a conventional optical circulator, a plurality of pass band filters, one for each signal, and a plurality of reflecting elements, one for each signal.

More in particular, in the PMD compensation scheme 19 of FIG. 7 there is provided an optical circulator 28 having an input port to receive the optical signals coming from the upstream span 10, N ports associated with N respective optical paths 29 and an output port to supply the optical signals, suitably compensated in PMD, to the downstream span 10. Moreover, in such a compensation scheme 19 there is also an optical amplifier 24 connected to the output port of the optical circulator 28 to amplify the optical signals in output from it.

According to the illustrated embodiment (FIG. 8), each optical path 29 comprises, in sequence, a pass band filter 30, a polarization controller 21, a polarizer 22, a reflecting element 31 and a control device 23.

In the same way as for the embodiment of FIG. 3a, instead of the polarization controller 21 and the polarizer 22, each optical path 29 can comprise a tunable polarizer.

As far as the structural and functional characteristics of the optical amplifier 24, of the polarization controller 21, of the polarizer 22 and of the control device 23 (and, possibly, of the tunable polarizer) are concerned we refer to what described above.

The pass band filter 30 typically comprises a fiber optic grating and is adapted to let the signal associated with the respective optical path 29 (for example the signal with wavelength λ2) pass and to reflect back all of the other signals (for example, the signals with wavelength λ1, λ3 . . . λN), towards the subsequent port of the optical circulator 28.

The reflecting element 31 typically comprises a fiber optic grating and is adapted to reflect back at least part of the optical signal at its input.

For example, in the illustrated embodiment, the reflecting element 31 is adapted to let a minimum power fraction (for example 5%) of the input optical signal pass through the output so as to supply such a power fraction to the control device 23.

According to an alternative (not shown) in which the reflecting element 31 has, on the other hand, a reflectivity of 100%, the optical path 29 shall comprise an optical coupler (of the previously described type) between the polarizer 22 and the reflecting element 31 adapted to draw a minimum power fraction from the optical signal and to supply it to the control device 23.

Due to the above, in the PMD compensation scheme 19 of FIGS. 7 and 8 the optical signals enter into the optical circulator 28 from its input port to then pass along the optical paths 29, to come out from the output port of the optical circulator 28 and, finally, to be amplified by the optical amplifier 24. In each optical path 29 the PMD of the optical signal not reflected back by the respective pass band filter 30 is compensated.

Analogously to what stated above, according to a preferred embodiment (not shown), in the PMD compensation scheme 19 of FIG. 7 a power regulator device is also provided. As far as the characteristics of such a power regulation device is concerned we refer to what described above. Moreover, in this embodiment of the PMD compensation scheme 19, the power regulation can also be obtained through a reflecting element 31 with a variable reflection coefficient (for example, a reflecting element 31 comprising a fiber optic grating with a reflection coefficient variable with temperature) and a control circuit adapted to regulate such a reflection coefficient.

In order to check the performance of the optical communication line according to the invention, the Applicant carried out computer simulations.

Such simulations were carried out taking into consideration an optical communication line comprising 5 fiber optic spans. Each span comprised in succession a transmission optical fiber length of 100 Km, a first PMD compensation device according to the invention, a chromatic dispersion compensation optical fiber length of 5 Km and a second PMD compensation device according to the invention. An optical amplifier was associated with each PMD compensation device as schematized in FIGS. 4. In the simulations, the optical amplifier was adapted to compensate for the losses due to both the PMD compensation device and the upstream optical fiber. Moreover, in reception a Bessel Thomson electric filter of the fourth order was considered. The noise of the optical amplifiers was not taken into consideration.

The pattern of the PMD was made assuming that the optical fibers consisted of a cascade of birefringent pieces having variable delay and birefringence orientation. Overall, over one thousand pieces were considered for each optical fiber length.

The analysis was carried out considering a transmission of the NRZ type (“Non Return to Zero”) and RZ type (“Return to Zero”), a bit rate of 10 Gbit/s and the transmission of a single optical signal at 1550 nm.

The optical band of the optical pulses was about 10 GHz in the case of NRZ transmission and about 15 GHz in the case of RZ transmission. Moreover, in the case of RZ transmission, gaussian pulses with full width half maximum (FWHM) equal to 40 ps were considered.

The main parameters used for the transmission optical fiber length (FTX) and chromatic dispersion compensator optical fiber length (FDC) are shown in the following table.

| | β₂ | β₃ | γ | α | PMD |
|---|---|---|---|---|---|
| | (ps²/Km) | (ps³/Km) | (W⁻¹*Km⁻¹) | (dB/Km) | (ps/Km^{1/2}) |
| FTX | −5 | 0 | 1.5 | 0.25 | 1.789 |
| FDC | 100 | 0 | 5 | 0.5 | 1.789 |

The considered values of dispersion, coefficient of non-linearity and losses are those typical for the two fiber types in question whereas the PMD coefficient considered corresponds to particularly critical optical fibers. To such a PMD coefficient value corresponds an average differential group delay (DGD) at the end of the line of about 40 ps (in other words, 40% of the bit slot).

Considering that—as known in the art—given a value of <DGD> (average DGD), the instantaneous DGD at a given frequency can vary from a value of 0 to a value equal to about 3*<DGD> according to a Maxwellian probability distribution, the simulations were repeated for a set of 10000 fibers having instantaneous DGD values, at the end of the line and at the central frequency of the signal, distributed according to such a Maxwellian distribution.

In FIGS. 9-15 the results of the simulations carried out in the case of NRZ transmission are shown.

In FIGS. 9a and 9b the Eye Opening Penalty (or EOP) values versus the instantaneous DGD at the end of the line is shown respectively in the absence and in the presence of the PMD compensation devices in the simulated line.

The EOP was calculated as the ratio (expressed in dB, i.e. 10*log₁₀) between the difference between the minimum “1” received and the maximum “0” received and the difference between the minimum “1” transmitted and the maximum “0” transmitted.

From FIG. 9 the improvement obtained with the PMD compensation scheme according to the invention is clear: in FIG. 9b the EOP value is always below 2 dB.

In FIGS. 10, 11 and 12 are respectively shown the evolution of the DOP along the line, the eye diagram and a portion of pattern received at the end of the line in the case of absence (FIGS. 10a, 11a, 12a) and presence (FIGS. 10b, 11b, 12b) of PMD compensation.

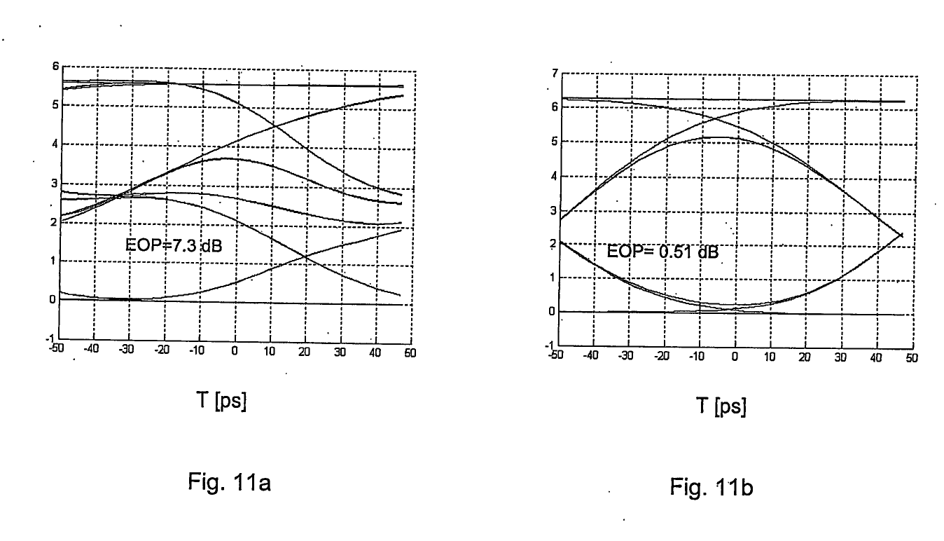

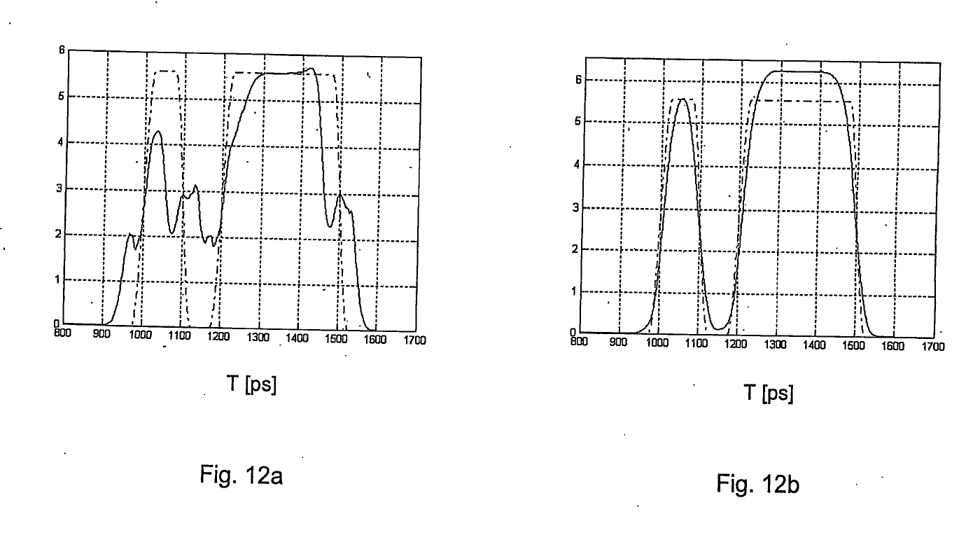

In FIG. 11 only the eye diagram of the pattern received is shown (that of the transmitted pattern has been left out). In turn, in FIG. 12 the broken line indicates the transmitted pattern whereas the continuous line indicates the received pattern.

As can be noted in FIGS. 10-12, the presence of the PMD compensators along the optical communication line, ensuring that the degree of polarization remains high along the line, allows the eye opening penalty to be drastically reduced and the optical pulses to be kept well confined in the bit slot.

As a comparison, in FIGS. 13, 14 and 15 are respectively shown the evolution of the DOP along the line, the eye diagram and a portion of pattern received at the end of the line for the same embodiment considered in FIGS. 10-12, but with a single PMD compensation device placed at the end of the line, as described in the aforementioned articles by Henrik Sunnerud et al. e M. Karlsson et al.

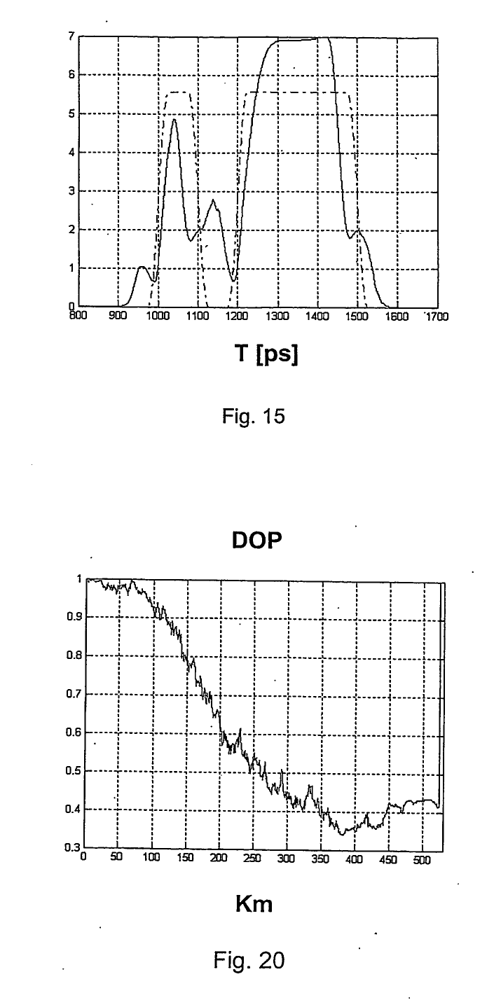

In FIG. 14 only the eye diagram of the pattern received is shown (that of the pattern transmitted has been left out) whereas in FIG. 15 the broken line indicates the pattern transmitted and the continuous line indicates the pattern received.

As can be noted from a comparison between FIGS. 10b and 13, FIGS. 11b and 14 and between FIGS. 12b and 15, the performance of the line according to the invention is considerably superior.

In FIGS. 16-22 the results of the simulations carried out in the case of RZ transmission are shown.

In FIGS. 16a and 16b the eye opening penalty (EOP) values versus the instantaneous DGD at the end of the line is shown respectively in the absence and in the presence of the PMD compensation devices in the simulated line.

Also in this case of RZ transmission, the improvement of the performance of the line according to the invention is substantial.

With respect to the NRZ case there is a worsening of about 1 dB. This worsening can be understood by observing FIG. 23 in which an example of variation of instantaneous DGD within a typical optical band of an optical signal (corresponding to about 30 GHz) is shown, in the case of an average DGD of 40 ps. The RZ pulses, having a greater band, undergo to a greater extent the negative impact of the dependence of the instantaneous DGD upon the frequency (or wavelength).

In FIGS. 17, 18 and 19 are respectively shown the evolution of the DOP along the line, the eye diagram and a portion of pattern received at the end of the line in the case of absence (FIG. 17a, 18a, 19a) and presence (FIG. 17b, 18b, 19b) of PMD compensation.

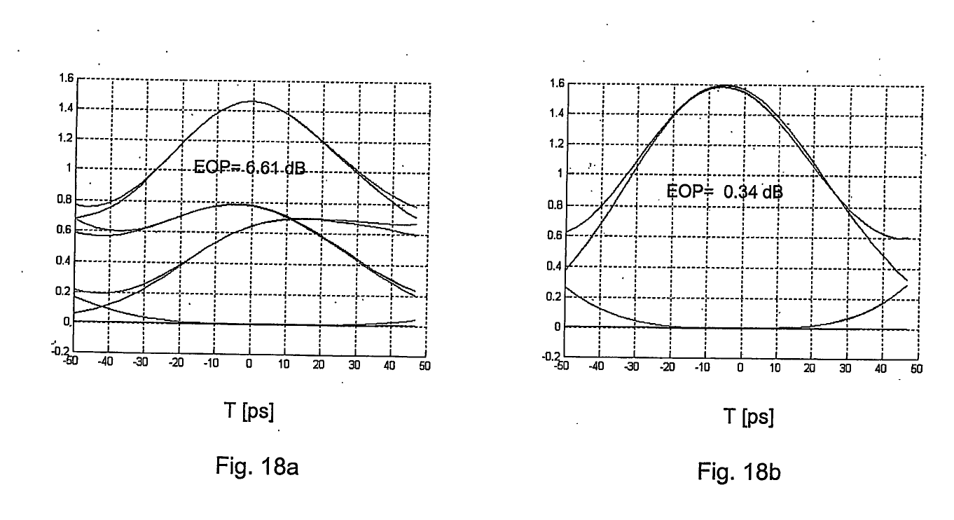

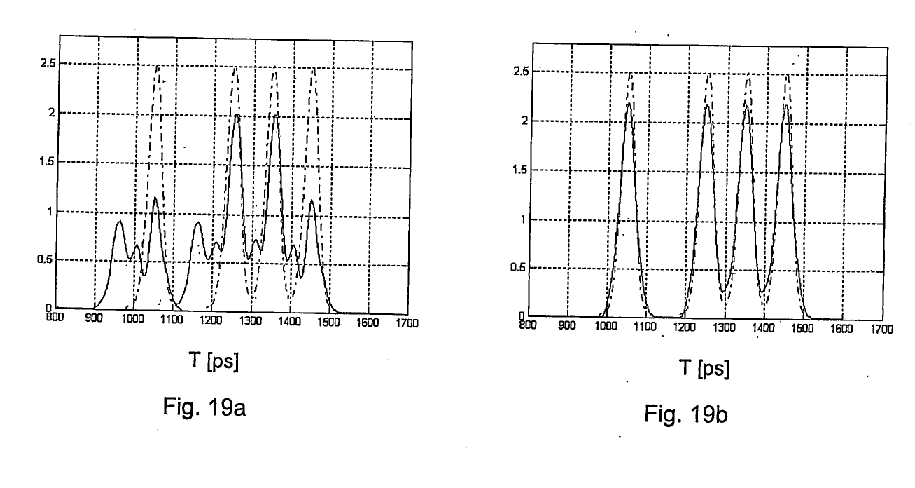

In FIG. 18 only the eye diagram of the pattern received is shown (that of the pattern transmitted has been left out). In turn, in FIG. 19 the broken line indicates the pattern transmitted whereas the continuous line indicates the pattern received.

From such figures, the improvement obtained with the invention is clear.

As a comparison, in FIGS. 20, 21 and 22 are respectively shown the evolution of the DOP along the line, the eye diagram and a portion of pattern received at the end of the line for the same embodiment considered in FIGS. 17-19, but with a single PMD compensation device placed at the end of the line as described in the aforementioned articles by Henrik Sunnerud et al. e M. Karlsson et al.

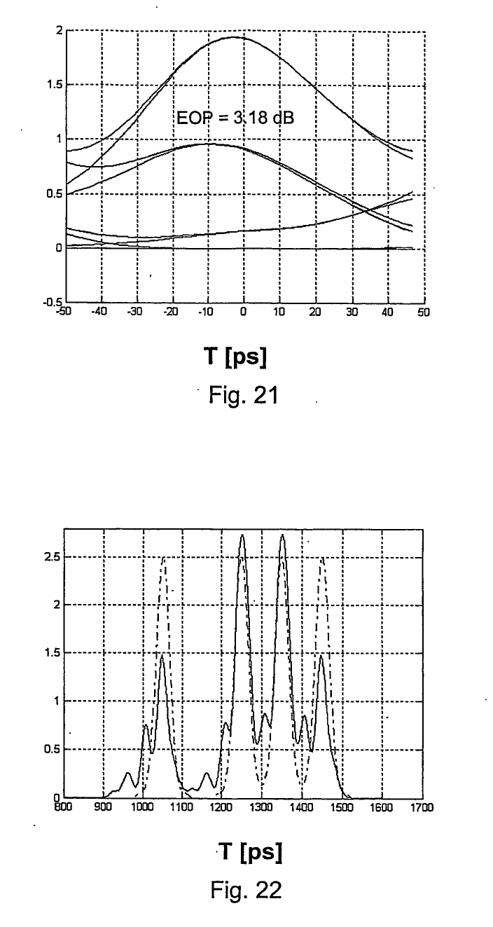

In FIG. 21 only the eye diagram of the pattern received is shown (that of the pattern transmitted has been left out). In turn, in FIG. 22 the broken line indicates the pattern transmitted whereas the continuous line indicates the pattern received.

As it can be noted from a comparison between FIGS. 17b and 20, FIGS. 18b and 21 and between FIGS. 19b and 22, the performance of the line according to the invention are considerably superior.

The Applicant carried out further computer simulations in order to evaluate the number of PMD compensation devices that it is advantageous to position along an optical communication line according to the invention to meet predetermined system requirements.

For both NRZ and RZ formats simulations have been carried out on a single optical signal at 1550 nm for a link having an overall length equal to 500 Km. Other effects (dispersion, non-linearity, losses) besides the PMD, which was assumed to be uniform along the line, were not taken into consideration. Therefore, it was not necessary to consider the presence of optical amplifiers along the line to compensate for the losses of the link. The average DGD values considered at the end of the line were 10, 15, 20, 25, 30, 35 and 40 ps.

For each average DGD value various configurations for PMD compensation were considered which differed from one another in the number of PMD compensation devices along the line and for the presence or absence of a PMD compensation device at the receiver.

The following conditions were examined:
absence of compensation
1 compensator at the receiver
1 compensator on line
1 compensator on line+1 compensator at the receiver
2 compensators on line
2 compensators on line+1 compensator at the receiver
3 compensators on line
3 compensators on line+1 compensator at the receiver
4 compensators on line
4 compensators on line+1 compensator at the receiver.

With n compensators on line the line was made up of n+1 spans of equal length, so that the overall length of the line was 500 Km. Having considered uniform PMD along the line, once the average DGD value at the end of the line has been set, the average DGD at the end of each individual span depended upon the length of the span and, therefore, upon the number of compensators considered on line. In the following table the length of the individual spans in correspondence with the number of compensators considered on line is indicated.

| Number of | | | | | |
|---|---|---|---|---|---|
| compensation | | | | | |
| stages on line | 0 | 1 | 2 | 3 | 4 |
| Length of the | 500 | 250 | 167 | 125 | 100 |
| individual spans | | | | | |
| [Km] | | | | | |

Analogously to what stated above, for each type of compensation scheme considered and for each average DGD value considered, the simulations were repeated for a statistical set of 10000 fibers having instantaneous DGD values at the end of the line and at the central frequency distributed according to Maxwellian distribution.

The performance of each type of considered compensation scheme was evaluated in terms of complementary probability distribution associated with the Eye Opening Penalty (EOP), defined as F(x)=P[EOP>x], that is as the probability that EOP is greater than x dB.

In FIGS. 24 and 25 the results obtained in the case of transmission at 10 Gbit/s and NRZ transmission format are shown.

More specifically, FIGS. 24 and 25 show P[EOP>x] versus EOP for an average DGD (E[DGD]) at the end of the line of 25 and 40 ps respectively. In such figures, the rhombuses, asterisks, triangles, squares, stars, full rhombuses, dotted line, broken line, dotted and dashed line and the continuous line respectively show the case of no compensator, 1 compensator at the receiver, 1 compensator on line, 1 compensator on line+1 compensator at the receiver, 2 compensators on line, 2 compensators on line+1 compensator at the receiver, 3 compensators on line, 3 compensators on line+1 compensator at the receiver, 4 compensators on line and 4 compensators on line+1 compensator at the receiver.

From such figures the improvement obtained with the invention can be noted. Moreover, the improvement obtained by increasing the number of compensation stages is clear. Nevertheless, the Applicant observes that according to the system requirements it is possible to obtain an effective compensation also with a limited number of compensators along the line.

From FIG. 25 the effectiveness of the PMD compensation according to the invention also for high average DGD values at the end of the line (for example, in the order of 40 ps) is also clear.

In FIGS. 26-28 (formed from an extrapolation of corresponding curves of P[EOP>x] of the type described above) the log₁₀ of the Outage probability (or O.P.) versus the average DGD at the end of the line is shown. The outage probability was evaluated establishing a threshold (in terms of EOP) beyond which the performance of the system is considered unacceptable and then calculating from the P[EOP>x] curves the probability of such a threshold being surpassed (for example, an outage probability of 10⁻⁵ corresponds to 5 min/year). FIGS. 26-28 were obtained for an EOP threshold respectively equal to 1, 1.5 and 2 dB. Moreover, in such figures the continuous line with the rhombuses, the broken line with the rhombuses, the continuous line with the triangles, the broken line with the triangles, the continuous line with the stars, the broken line with the stars, the continuous line with the circles, the broken line with the circles, the continuous line and the broken line respectively show the results obtained in the case of no compensator, 1 compensator at the receiver, 1 compensator on line, 1 compensator on line+1 at the receiver, 2 compensators on line, 2 compensators on line+1 at the receiver, 3 compensators on line, 3 compensators on line+1 at the receiver, 4 compensators on line e 4 compensators on line+1 at the receiver.

From such figures the improvement obtained with the invention is clear.

Once the EOP threshold has been selected, the outage probability required by the system has been established and the average DGD value at the end of the line has been known, from FIGS. 26-28 an indication of the number of PMD compensation devices necessary to meet the system requirements can be obtained.

Moreover, the Applicant observes that, although the simulations were carried out assuming uniform PMD along the line, they also provide useful information for non-uniform PMD cases. For example, let us consider the case of a link of 5 spans, of which the first two spans with average DGD equal to 20 ps and the others with negligible PMD. Such a link has an average DGD equal to 30 ps. In this case two PMD compensation devices can be used, positioned downstream of the first two spans. From an analysis of FIGS. 26-28 in correspondence with 2 stages on line and an average DGD at the end of the link of 30 ps, it can be worked out that such a link would have a P[EOP>1 dB] of 10⁻⁴, a P[EOP>1.5 dB] of about 10⁻⁶ and a P[EOP>2 dB] of about 10⁻⁸.

In the compensated optical communication line according to the invention it is, therefore, possible to obtain acceptable performance also with a limited number of PMD compensation devices on line. This allows, especially in WDM communication systems, the architecture of the line to be simplified and its costs to be reduced.

FIGS. 29 and 30 show the results obtained in the case of transmission at 10 Gbit/s, RZ transmission format and gaussian pulses with full width half maximum T_{FWHM} of 40 ps.

The simulations were carried out in totally the same way as the case of NRZ transmission and considering the same compensation schemes.

More specifically, FIGS. 29 and 30 show P[EOP>x] versus EOP for an average DGD at the end of the line respectively of 25 and 40 ps. In such figures, the rhombuses, asterisks, triangles, squares, stars, full rhombuses, dotted line, broken line, dotted and dashed line and the continuous line respectively show the case of no compensator, 1 compensator at the receiver, 1 compensator on line, 1 compensator on line+1 compensator at the receiver, 2 compensators on line, 2 compensators on line+1 compensator at the receiver, 3 compensators on line, 3 compensators on line+1 compensator at the receiver, 4 compensators on line and 4 compensators on line+1 compensator at the receiver.

Also in this case, the improvement obtained with the invention as the number of compensation stages increases is clear. In absolute terms, the maximum improvement obtainable is lower with respect to the case of NRZ transmission, mainly due to the greater optical band of RZ pulses.

In the same way as FIGS. 26-28, FIGS. 31-33 show the outage probability versus the average DGD at the end of the line for an EOP threshold respectively equal to 1, 1.5 and 2 dB. In such figures the continuous line with the rhombuses, the broken line with the rhombuses, the continuous line with the triangles, the broken line with the triangles, the continuous line with the stars, the broken line with the stars, the continuous line with the circles, the broken line with the circles, the continuous line and the broken line respectively show the results obtained in the case of no compensator, 1 compensator at the receiver, 1 compensator on line, 1 compensator on line+1 at the receiver, 2 compensators on line, 2 compensators on line+1 at the receiver, 3 compensators on line, 3 compensators on line+1 at the receiver, 4 compensators on line and 4 compensators on line+1 at the receiver.

Also in this case, the improvement obtained with the invention as the number of compensation stages increases is clear. Nevertheless, for not too high average DGD values of the line, the PMD is effectively compensated for also with a low number of compensation stages.

1-26. (canceled)

27. An optical communication line for transmitting an optical signal having a predetermined wavelength comprising a plurality of spans and at least one PMD compensation device adapted to process said optical signal so as to obtain in output a polarized optical signal having associated a maximum power fraction of said optical signal, said PMD compensation device being inserted between two spans of the line.

28. The optical communication line according to claim 27, wherein said. polarized optical signal is linearly polarized.

29. The optical communication line according to claim 27, wherein the PMD compensation device is adapted to obtain in output an optical signal polarized according to a predetermined state of polarization and to adjust the polarization of said optical signal so as to maximize the optical power associated with said optical signal polarized according to said predetermined state of polarization.

30. The optical communication line according to claim 29, wherein the PMD compensation device comprises a polarizer adapted to obtain in output said optical signal polarized according to said predetermined state of polarization.

31. The optical communication line according to claim 30, wherein the PMD compensation device further comprises a polarization controller adapted to adjust the polarization of said optical signal.

32. The optical communication line according to claim 31, wherein the PMD compensation device further comprises a control device adapted to receive a power fraction of the polarized optical signal in output from the polarizer to analyze the received signal and to drive the adjustment introduced by the polarization controller so as to maximize the power of the polarized optical signal in output from the polarizer.

33. The optical communication line according to claim 27, wherein the PMD compensation device comprises a tunable polarizer adapted to obtain in output said polarized optical signal.

34. The optical communication line according to claim 33, wherein the PMD compensation device further comprises a control device adapted to receive a power fraction of the polarized optical signal in output from the tunable polarizer to analyze the received signal and to drive the tunable polarizer so as to maximize the optical power associated with the polarized optical signal in output from the tunable polarizer.

35. The optical communication line according to claim 27, further comprising at least one optical amplifier.

36. The optical communication line according to claim 35, wherein said optical amplifier is associated with the PMD compensation device.

37. The optical communication line according to claim 27, wherein the line is adapted to transmit a plurality of N optical signals at wavelengths different from each other and comprises, between two spans, a plurality of N optical paths, one for each of said N optical signals, each comprising a PMD compensation device adapted to process a respective optical signal among said N optical signals so as to obtain in output a respective polarized optical signal having associated a maximum power fraction of said respective optical signal.

38. The optical communication line according to claim 37, further comprising a demultiplexing device having an input for receiving said plurality of N optical signals and N outputs connected to said N optical paths, said demultiplexing device being adapted to separate said N optical signals and to supply them to the respective optical paths.

39. The optical communication line according to claim 38, further comprising a multiplexing device having N inputs connected to said N optical paths and one output, said multiplexing device being adapted to combine on said output the polarized optical signals coming from the N optical paths.

40. The optical communication line according to claim 37, further comprising an optical circulator having an input port for said plurality of N optical signals and N ports connected to said N optical paths.

41. The optical communication line according to claim 40, wherein the optical circulator further comprises an output port for the polarized optical signals coming from the N optical paths.

42. The optical communication line according to claim 40, wherein each optical path comprises, at a first end thereof in proximity of the respective port of the optical circulator, a pass band filter adapted to let the respective optical signal pass and to reflect back the other N-1 optical signals.

43. The optical communication line according to claim 42, wherein each optical path further comprises, at a second end thereof opposite the first end, a reflecting element adapted to reflect back, towards the respective port of the optical circulator, at least one portion of the respective optical signal.

44. The optical communication line according to claim 37, further comprising a power regulation device associated with said plurality of N optical paths adapted to regulate the power of the polarized optical signals.

45. The optical communication line according to claim 44, wherein said power regulation device is adapted to substantially equalize the power of the polarized optical signals at the output of said plurality of N optical paths.

46. The optical communication line according to claim 44, wherein said power regulation device comprises a plurality of optical attenuators each associated with a respective optical path.

47. The optical communication line according to claim 44, wherein said power regulation device comprises a plurality of optical amplifiers each associated with a respective optical path.

48. The optical communication line according to claim 44, wherein said power regulation device comprises a dynamic gain equalizer positioned downstream of said plurality of N optical paths.

49. The optical communication line according to claim 43, wherein the reflecting element has a variable reflection coefficient and each optical path further comprises a control circuit of said reflection coefficient so as to regulate the level of optical power of the respective polarized optical signal.

50. The optical communication system comprising an optical communication line according to claim 27, a transmitting station adapted to supply said optical signal or said plurality of N optical signals to the line and a receiving station to receive said optical signal or said plurality of N optical signals from the line.

51. A method of obtaining in output a polarized optical signal having associated a maximum power fraction of an input optical signal having a predetermined wavelength comprising placing a PMD compensation device between two spans of an optical communication line, said PMD compensation device being adapted to process said input optical signal having a predetermined wavelength.

52. A method for reducing the PMD of an optical signal having a predetermined wavelength which propagates along an optical communication line comprising at least two spans, said method comprising the steps of:
a) processing the optical signal coming from one of the two spans so as to obtain a polarized optical signal with associated a maximum power fraction of said optical signal; and
b) supplying said polarized optical signal to the other of the two spans.
